(19) United States
(12) Patent Application Publication
(10) Pub. No.: US 2014/0157440 A1
(43) Pub. Date: Jun. 5, 2014

(54) METHODS, APPARATUS, AND ARTICLES OF MANUFACTURE TO ENCODE AUXILIARY DATA INTO NUMERIC DATA AND METHODS, APPARATUS, AND ARTICLES OF MANUFACTURE TO OBTAIN ENCODED DATA FROM NUMERIC DATA

(71) Applicants: Nikolay Georgiev, San Jose, CA (US); Leonid Ayzenshtat, Jacksonville, FL (US)

(72) Inventors: Nikolay Georgiev, San Jose, CA (US); Leonid Ayzenshtat, Jacksonville, FL (US)

(21) Appl. No.: 13/691,519

(22) Filed: Nov. 30, 2012

(51) Int. Cl. G06F 21/16

(52) U.S. Cl. CPC G06F 21/16
USPC 726/32

(57) ABSTRACT

Methods, apparatus, and articles of manufacture to encode auxiliary data into numeric data and methods, apparatus, and articles of manufacture to obtain encoded data from numeric data are disclosed. An example method to embed auxiliary information into numeric data includes assigning source data to one of a plurality of groups, the source data comprising a numeric value, identifying a symbol to be added to the source data based on an assigned group of the source data, and generating encoded data by selectively modifying the numeric value of the source data to be representative of the symbol.

### FIELD OF THE DISCLOSURE

This disclosure relates generally to data encoding, and, more particularly, to methods, apparatus, and articles of manufacture for encoding auxiliary information in numeric data and to methods, apparatus, and articles of manufacture for obtaining encoded auxiliary information from numeric data.

### BACKGROUND

Proprietary data is sometimes shared between two parties. In some cases, the proprietary data owned by one party is easily copied or distributed by the other party to additional parties without consent of the owner.

### BRIEF DESCRIPTION OF THE DRAWINGS

FIG. 1 is a block diagram of an example system in accordance with the teachings of this disclosure.

FIG. 2 is a more detailed block diagram of an example auxiliary data encoder to implement the system of FIG. 1 in accordance with the teachings of this disclosure.

FIG. 3 is a more detailed block diagram of an example auxiliary data decoder to implement the system of FIG. 1 in accordance with the teachings of this disclosure.

FIG. 4 is a table illustrating example source data, auxiliary data, and resulting encoded data in accordance with the teachings of this disclosure.

FIG. 5 is a table illustrating another example of source data, auxiliary data, and resulting encoded data in accordance with the teachings of this disclosure.

FIG. 6 is a table illustrating another example of source data, auxiliary data, and resulting encoded data in accordance with the teachings of this disclosure.

FIG. 7 is a flowchart representative of example machine readable instructions which may be executed to implement the auxiliary data encoder of FIG. 2 to encode auxiliary data into numeric data.

FIG. 8 is a flowchart representative of example machine readable instructions which may be executed to implement the auxiliary data decoder of FIG. 3 to obtain auxiliary data encoded into numeric data.

FIG. 9 is a block diagram of an example computer capable of executing the instructions of FIGS. 7-8 to implement the apparatus of FIGS. 2 and/or 3.

### DETAILED DESCRIPTION

Data (whether copyrighted or not) can be distributed. However, once distributed a first time, the data is capable of being further distributed. Example methods, apparatus, and articles of manufacture disclosed herein enable an owner of data to uniquely identify, protect, and trace the data to detect cases of unauthorized copying or redistribution by embedding auxiliary data, also referred to herein as watermarks, in the data. In particular, example methods, apparatus, and articles of manufacture embed watermarks in the data in a robust manner, such that the watermark can still be recovered if a portion of the data is copied and/or if the data is reorganized.

Example methods, apparatus, and articles of manufacture disclosed herein provide an innovative approach for embedding watermarks inside numeric data. Example methods, apparatus, and articles of manufacture disclosed herein may be used to robustly encode a watermark or other auxiliary data into numeric data.

Example methods, apparatus, and articles of manufacture enable content owners to secure the distributed content, prevent unauthorized usage of the data, and/or provide the means to combat copyright infringement. Example methods, apparatus, and articles of manufacture can be used, for example, to embed a watermark into all distributed data. In the event of unauthorized distribution, the watermark in the numeric data can be decoded to prove the origin of the data. Example methods, apparatus, and articles of manufacture can also be used to embed a client specific fingerprint to personalize the copy of data. When data is found to have been improperly distributed, the specific fingerprint may be used to identify a party who was in possession of the data prior to the improper distribution.

By encoding data independently into the data units of the numeric data based on a hash function or other algorithm, encoding carried out using the example methods, apparatus, and articles of manufacture disclosed herein is highly resilient against shuffling, reordering, and/or partial deletion of the data. Example methods, apparatus, and articles of manufacture enable a lightweight implementation of the watermarking and little to no overhead in the encoded data relative to the source data. Furthermore, the presence of watermarks encoded into the numeric data using the example methods, apparatus, and articles of manufacture disclosed herein is difficult to identify without access to the source data. Thus, watermarks encoded into the numeric data using the example methods, apparatus, and articles of manufacture are effectively hidden to consumers of the data.

In some examples, the numeric data is divided (or divisible) into data units. To encode auxiliary data into the numeric data, example methods, apparatus, and articles of manufacture determine symbols (e.g., bits) to represent the auxiliary data. Each symbol may be recovered by any data unit in a group of data units. Example methods, apparatus, and articles of manufacture apply a hash algorithm to each of the data units to assign each data unit to one of the groups. The data units are encoded with the symbol corresponding to the groups to which the data units are assigned.

In some examples, the encoding is robust because the auxiliary data can be recovered from a subset of the data set as long as the subset includes at least one data unit from each group.

In some examples, encoding a symbol into a data unit includes altering the numeric value of the data unit. In some such examples, the least significant digit of the data is selectively changed. In some other examples, multiple least significant digits of a data unit are selectively changed.

In some examples, changing figures in the numeric data does not meaningfully alter the value of the numeric data because the change to the numeric data is within a margin of error. In some examples, the numeric data is modified to represent the symbol to be encoded and in other cases the numeric data does not need to be modified to represent the symbol (e.g., the numeric data is self-encoded). For example, a data unit may be modified to be representative of a symbol associated with the assigned group. If the symbol is a ‘1’ bit, the numeric data may be modified to be odd when the data unit is an even number and not modified when the data unit is an odd number. Conversely, if the symbol is a ‘0’ bit, the numeric data may be modified to be even when the data unit is an odd number and not modified when the data unit is an even number.

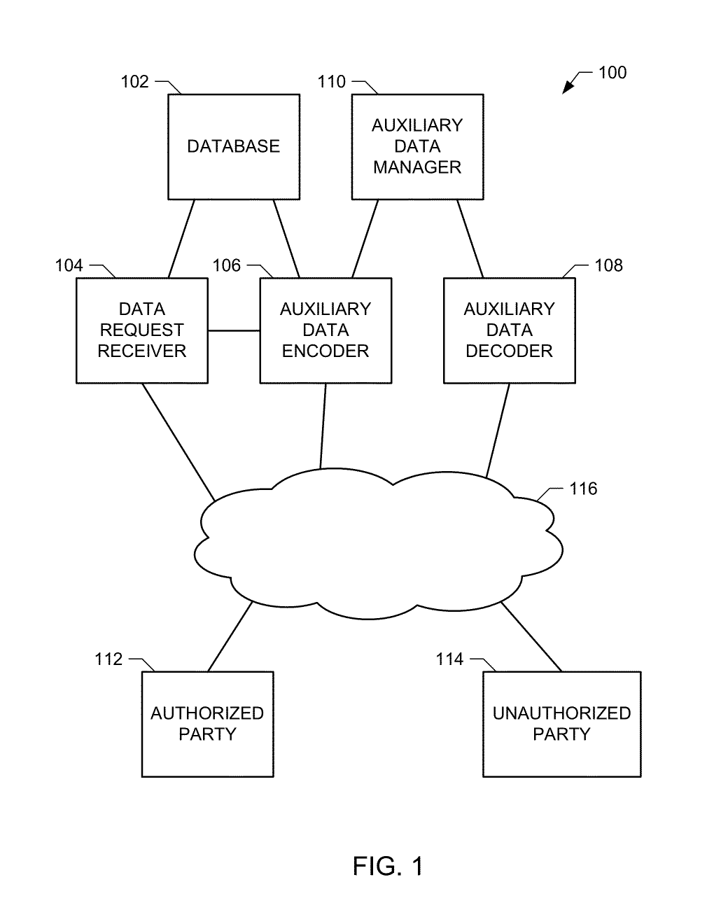

FIG. 1 is a block diagram of an example system 100. The example system 100 of FIG. 1 may be used to encode auxiliary information (e.g., watermarks) into numeric data that may subsequently be distributed. The example system 100 may further decode numeric data to recover or obtain auxiliary information encoded using the system 100. Thus, subsequent to distribution of the encoded numeric data, the example system 100 can identify numeric data that has been encoded using the system 100.

The example system 100 of FIG. 1 includes a database 102, a data request receiver 104, an auxiliary data encoder 106, an auxiliary data decoder 108, and an auxiliary data manager 110. In the example of FIG. 1, the database 102, the data request receiver 104, the auxiliary data encoder 106, the auxiliary data decoder 108, and the auxiliary data manager 110 are owned or controlled by a single party (e.g., an owner or licensee of distributable data, a distributor of the data under the control of the owner or licensee of the data, etc.). In some other examples, the database 102, the data request receiver 104, the auxiliary data encoder 106, the auxiliary data decoder 108, and/or the auxiliary data manager 110 may represent a combination of multiple parties. The example system 100 further includes a party 112 authorized to receive data stored in the database 102 and a party 114 not authorized to receive such data. Any or all of the example database 102, the example data request receiver 104, the example auxiliary data encoder 106, the example auxiliary data decoder 108, the auxiliary data manager 110, and/or the example parties 112, 114 may be communicatively connected via a network 116 such as the Internet.

Any of the example blocks 102-110 of FIG. 1 may be combined, divided, and/or rearranged to form different blocks that perform fewer or more functions.

As mentioned above, the example database 102 stores data that may be distributed. In the example system 100, the data stored in the database (also referred to herein as “source data”) includes (or is divisible into) data units having numeric values. In addition to the numeric value of the data unit, the data unit may include organizational data, metadata, and/or other types of non-substantive data for the purposes of organization, relation, and/or distribution. In some examples, the numeric value is the entirety of the data unit. Example data includes a table of numeric values and associated information (e.g., descriptions of the numeric data). The data stored in the database 102 may be updated to add new data, to modify data present in the database 102, and/or to delete data from the database 102.

The example data request receiver 104 of FIG. 1 receives requests for data stored in the database 102. For example, the data request receiver 104 may receive a request via the network (e.g., from the authorized party 112 and/or other parties). Additionally or alternatively, the data request receiver 104 may receive requests via manual entry of the request into the data request receiver (e.g., by a person via a user interface). The example data request receiver 104 parses the request to determine the data that was requested to be transferred and/or determines whether the requesting party has authorization to receive the data. For example, in response to a request the data request receiver 104 may construct a query of the database 102 to instruct the database and/or the auxiliary data encoder 106 which data is to be encoded before it is transmitted.

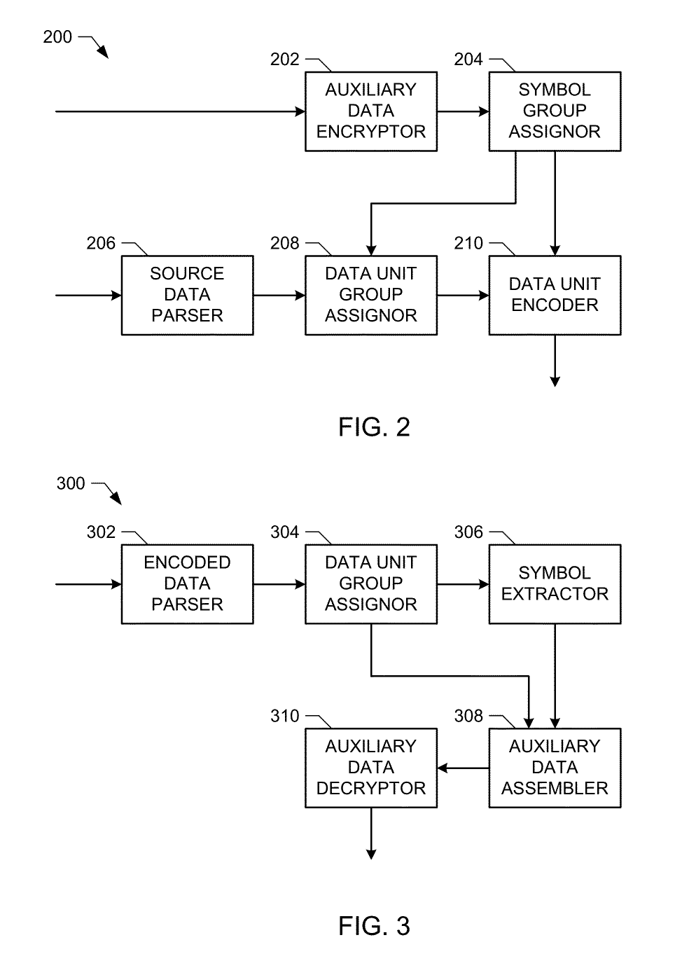

The example auxiliary data encoder 106 of FIG. 1 receives the source data to be encoded (e.g., as individual data units, as a set of data units, etc.), encodes auxiliary information into the source data, and outputs encoded data (e.g., for distribution, for storage, etc.). A more detailed example of the auxiliary data decoder 108 is described below in conjunction with FIG. 2.

The example auxiliary data decoder 108 of FIG. 1 obtains data in which auxiliary information may be present (e.g., suspect data) and attempts to extract the auxiliary information based on the method used by the auxiliary data encoder 106 to encode auxiliary data into numeric data. In some examples, the auxiliary data decoder 108 attempts to extract auxiliary data from the suspect data using multiple decoding methods, each decoding method being based on a method used by the auxiliary data encoder 106 to encode data. The auxiliary data decoder 108 may obtain data to be decoded when, for example, the obtained data is suspected of having been distributed without authorization and/or the owner or source of the obtained data is to be demonstrated.

The example auxiliary data manager 110 of FIG. 1 provides auxiliary information to the auxiliary data encoder 106, which encodes the auxiliary information into numeric data. The example auxiliary data manager 110 also receives extracted auxiliary information from the auxiliary data decoder 108. The auxiliary data manager 110 compares extracted auxiliary information to auxiliary information provided to the auxiliary data encoder 106 to determine whether a match exists between auxiliary information provided to the auxiliary data encoder 106 and auxiliary information extracted by the auxiliary data decoder 108. The example auxiliary data manager 110 maintains (e.g., logs) a record of the parties to whom data is distributed and the auxiliary information encoded into the data provided to the parties. Thus, the example auxiliary data manager 110 can determine a party to whom data including a particular watermark was distributed. In some examples, the auxiliary data manager 110 identifies the data as having been distributed from the database 102 or otherwise encoded via the auxiliary data encoder 106 when a match exists between auxiliary information provided to the auxiliary data encoder and auxiliary information extracted by the auxiliary data decoder 108.

FIG. 2 is a more detailed block diagram of an example auxiliary data encoder 200 to implement the system 100 of FIG. 1. The example auxiliary data encoder 200 of FIG. 2 may implement the auxiliary data encoder 106 of FIG. 1 to encode auxiliary data into numeric source data. Source data, as used herein, refers to data into which auxiliary information is to be encoded. Example source data may include measurement data, survey data, and/or any other type of data that may be represented by sets of numeric values. In the example of FIG. 2, the auxiliary data encoder 200 encodes the auxiliary information in the source data in a binary format.

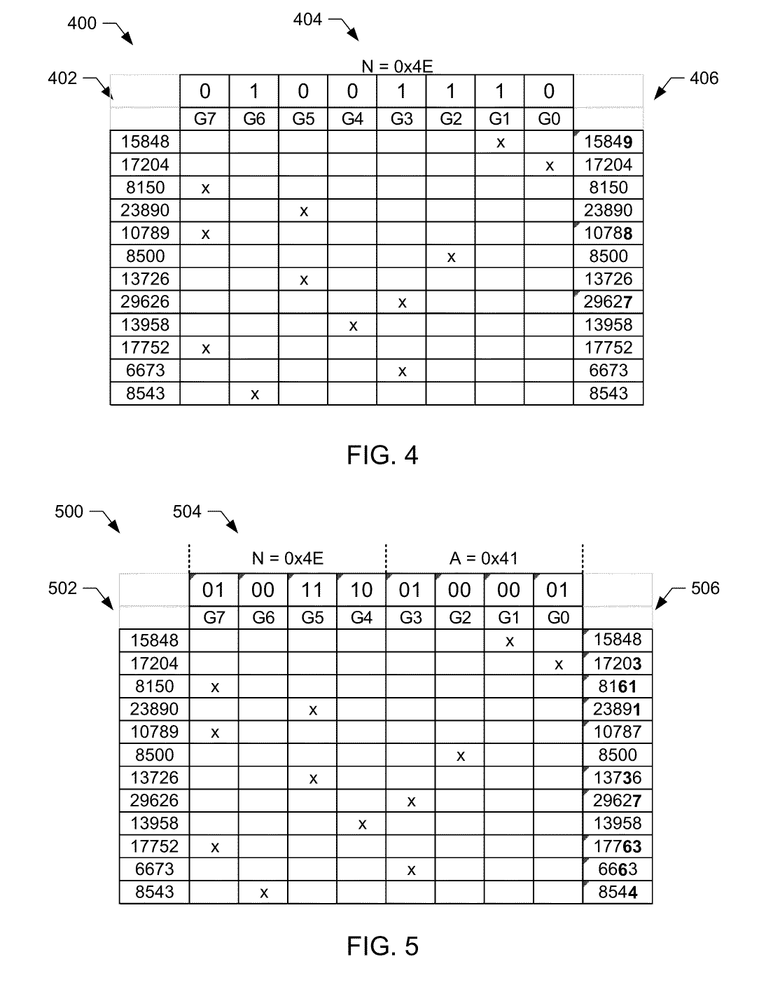

The auxiliary data encoder 200 of the illustrated example includes an auxiliary data encryptor 202, a symbol group assignor 204, a source data parser 206, a data group assignor 208, and a data unit encoder 210. The example auxiliary data encryptor 202 receives or otherwise obtains auxiliary data to be encoded into source data (e.g., from the auxiliary data manager 110 of FIG. 1). The example source data parser 206 receives or obtains source data including a numeric value (e.g., from the database 102 of FIG. 1). In some examples, the source data parser 206 serially receives data units and the auxiliary data encryptor 202 receives a string or other data to be encoded into the source data. Examples of source data, auxiliary data, and encoding the auxiliary data into the source data are described below with reference to FIGS. 4, 5, and 6.

The example auxiliary data encryptor 202 encrypts received auxiliary data. Encryption may be performed using any encryption method. In some examples, the auxiliary data encryptor 202 receives a key to be used for encrypting the auxiliary data. By encrypting auxiliary data, the example auxiliary data encryptor 202 makes the auxiliary data more difficult to detect in the encoded data relative to unencrypted auxiliary data.

The auxiliary data encryptor 202 provides the encrypted data to the symbol group assignor 204. The symbol group assignor 204 determines a number of groups to represent the encrypted data. In some examples, each bit of the encrypted data corresponds to a symbol and is represented by one group. In some other examples, multiple bits of the encrypted data correspond to each symbol and are represented by each group. In some examples, different symbols represent different numbers of bits, and are assigned to groups that represent the number of bits represented by the symbol. In other words, in an example, some symbols may represent 1 bit and some other symbols may represent 2 bits. The different bit rates of the symbols may be used to increase the robustness of the encoding, to increase the data encoded in the source data, and/or some combination thereof. The symbols are encoded in the source data according to the groups to which the source data is assigned, as described below.

The groups are provided with a designated order. For example, 4 groups designated G0, G1, G2, and G3 may be arranged in order from least significant symbol (e.g., least significant bit, least significant bits, least significant word, etc.) to most significant symbol (e.g., most significant bit, most significant bits, most significant word, etc). The order may be according to convention (e.g., least significant on the right, most significant on the left, or vice versa) or may be pseudorandom. In some examples, the order in which the groups are arranged for encoding is the same order in which the groups are arranged for decoding.

The example source data parser 206 of FIG. 2 receives the source data (e.g., data units) including a numeric value. In some examples, the source data parser 206 generates data units from a set of numeric values. The source data parser 206 may remove one or more figures from the data (e.g., convert the numbers from millions to thousands, etc.).

The example data unit group assignor 208 of FIG. 2 assigns data units to groups. As a result, distinct subsets of the data units are assigned to the groups, where the subsets do not overlap. For example, the data unit group assignor 208 of FIG. 2 applies a hash algorithm to each data unit to determine to which group the data unit is to be assigned. Any hash algorithm may be used to determine the group, provided that applying the hash algorithm or another hash algorithm determines the same group for the resulting encoded data as for the source data. The example data unit group assignor 208 of FIG. 2 uses characteristics of the data unit that are not subject to change by the encoding process, such as the values of selected figures in the data unit, to evaluate the hash algorithm. In the example of FIG. 2, the data unit group assignor 208 uses a hash algorithm selected to assign approximately equal numbers of data units to each of the groups.

The example data unit group assignor 208 uses a hash algorithm including a modulo operator to limit the results of the hash algorithm to be within the set of groups. To this end, the example data unit group assignor 208 may receive a number of groups from the symbol group assignor 204. The number of groups is implemented in the hash algorithm to assign the data units to the groups. An example of a hash algorithm that may be used by the data unit group assignor 208 to perform a modulo operation on the numeric data that is not subject to being changed for encoding, with the base of the modulo operation being the number of groups.

As an example, if the numeric data is 17465, the least significant figure (e.g., 5) is selectively modified to encode the data, and there are 8 groups, the example data unit group assignor 208 of FIG. 2 removes the least significant figure (e.g., 5) and performs a modulo 8 operation on the remaining number (e.g., 1746), with the result being 2. In some other examples, the hash algorithm may perform other operations on the data, perform modulo operations on particular figures in the data, and/or otherwise manipulate the numeric data to obtain the group assignment.

The example data unit encoder 210 receives source data and identifications of groups to which the source data are assigned from the data unit group assignor 208 and receives the symbols assigned to the identified groups from the symbol group assignor 204. The data unit encoder 210 encodes the symbols in the source data to generate encoded data. For example, the data unit encoder 210 may determine whether the data unit is an odd or even number, determine whether the symbol to be encoded is a ‘1’ bit or a ‘0’ bit based on the assigned group, and change the least significant figure of the data unit if necessary to match (or not match) the symbol. The data unit encoder 210 outputs the encoded data (e.g., to a requesting party, to be stored, etc.).

In some examples in which symbols represent multiple bits, the data unit encoder 210 determines an assignment of the bits to corresponding figures in the numeric value. For example, a 2-bit symbol may be assigned to the 2 least significant figures of the numeric value by assigning a first one of the bits to the least significant figure of the numeric value and assigning the second one of the bits to the second least significant figure of the numeric value.

In the example of FIG. 2, the data unit encoder 210 selectively modifies the least significant figure of the data so as to avoid modifying additional figures of the data and/or to avoid affecting any subsequent rounding operations. For example, when the digit to be modified is 0 or 5, the example data unit encoder 210 selectively increases the digit to encode the data. Conversely, when the digit to be modified is 4 or 9, the example data unit encoder 210 selectively decreases the digit to encode the data. As a result, additional digits and/or rounding operations are not affected by the encoding. When the digit to be modified is 1, 2, 3, 6, 7, or 8, the example data unit encoder 210 may increase or decrease the digit to encode the data without affecting additional digits or rounding operations.

In another example, the data unit encoder 210 sets the value of the least significant figure(s) of the data unit to a designated value corresponding to the symbol to be encoded. For example, each symbol that may be encoded into the data unit may be assigned designated figure(s). For instance, a two-bit symbol can have 4 different values. Each of the values is assigned (e.g., mapped to) between 1 and 3 designated decimal numbers (for decimal numeric data). The data unit encoder 210 may selectively modify the value of the least significant figure of the numeric data to be equal one of the number(s) assigned to the symbol.

While the example auxiliary data encoder 200 of FIG. 2 includes the auxiliary data encryptor 202, other auxiliary data encoders 200 omit the auxiliary data encryptor 202 and encode unencrypted auxiliary data into the source data. In such examples, the symbol group assignor 204 receives the auxiliary data and assigns symbols representative of the unencrypted auxiliary data to the groups. Operational examples of the auxiliary data encoders 200 are described below with reference to FIGS. 4-6.

FIG. 3 is a more detailed block diagram of an example auxiliary data decoder 300 to implement the system 100 of FIG. 1. The example auxiliary data decoder 300 of FIG. 3 may implement the auxiliary data decoder 108 of FIG. 1 to extract or decode auxiliary data from encoded data including numeric values. The auxiliary data decoder 300 of the illustrated example includes an encoded data parser 302, a data unit group assignor 304, a symbol extractor 306, an auxiliary data assembler 308, and an auxiliary data decryptor 310.

The example encoded data parser 302 of FIG. 3 obtains encoded data (or data suspected of containing encoded auxiliary data). For example, a set or subset of numeric data (e.g., measurement data) that is suspected (or known) to have been owned or sourced by a first party is found in the possession of another party not authorized to possess the data. In some examples, the encoded data parser 302 generates data units from the source data, while in other examples the encoded data parser 302 receives or obtains the source data as data units.

The example encoded data parser 302 provides the data units to the data unit group assignor 304. The example data unit group assignor 304 of FIG. 3 assigns the data units to groups. In some examples, the data unit group assignor 304 uses the same method of group assignment (e.g., the same hash algorithm) as used by a corresponding data unit group assignor of an auxiliary data encoder (e.g., the 208 data unit group assignor of the auxiliary data encoder 208 of FIG. 2). In some other examples, the data unit group assignor 304 of FIG. 3 uses a complementary algorithm to the algorithm used by the data unit group assignor 208 to assign the encoded data units to the same respective groups as the corresponding source data units.

The example symbol extractor 306 of FIG. 3 extracts a symbol from the data unit. For example, the symbol extractor 306 may determine a value of the least significant figure(s) to determine a symbol represented by the data unit. In an example in which an odd numeric value corresponds to a ‘1’ bit and an even number corresponds to a ‘0’ bit, the symbol extractor 306 may determine the value of the data unit by determining whether the data unit is an odd or an even number. In another example, the symbol extractor 306 determines whether multiple figures are odd and/or even to determine a value of the symbol. For example, the symbol extractor 306 may determine a first bit of the symbol by determining whether a first figure is odd or even, determine a second bit of the symbol by determining whether a second figure is odd or even, and so on for the number of bits of the symbol. In another example, the symbol extractor 306 determines a value of a figure of the data unit and maps the value to a symbol. For example, the symbol extractor 306 may determine a symbol mapped to the least significant figure of the data unit.

The example auxiliary data assembler 308 of FIG. 3 receives extracted symbols from the symbol extractor 306 and corresponding assigned groups from the data unit group assignor 304. The example auxiliary data assembler 308 assembles the auxiliary data by arranging the symbols in the locations designated by the groups. In the example of FIG. 3, each group corresponds to bit(s) in a particular location or position in the auxiliary data. In particular, the example groups assigned by the data unit group extractor 304 correspond to the same positions assigned by the data unit group assignor 208 of FIG. 2. In some other examples, the group locations or positions assigned by the data unit group extractor 304 differ from the assigned groups in a deterministic (e.g., pseudorandom) manner. In these examples, the auxiliary data assembler 308 determines the group locations or positions used during encoding from the group locations assigned during decoding.

The example auxiliary data assembler 308 provides the assembled auxiliary data to the auxiliary data decryptor 310. The example auxiliary data decryptor 310 decrypts the assembled auxiliary data to obtain decrypted auxiliary data (e.g., the original auxiliary data to be encoded in the source data). The example auxiliary data decryptor 310 outputs the decrypted auxiliary data (e.g., to the auxiliary data manager 110 of FIG. 1). The decrypted auxiliary data may then be used to compare to previously-encoded auxiliary data and/or read to obtain information encoded as auxiliary data.

FIG. 4 is a table 400 illustrating example source data 402, auxiliary data 404, and resulting encoded data 406. The example source data 402, auxiliary data 404, and resulting encoded data 406 are described with reference to FIGS. 2 and 3 to illustrate an example of encoding of the auxiliary data 404 into the source data 402 by the auxiliary data encoder 200 of FIG. 2, and an example of obtaining the auxiliary data 404 from the encoded data 406. For the sake of clarity, the example auxiliary data 404 is not encrypted in the example of FIG. 4. The example source data 402 of FIG. 4 are data units including numeric values.

The auxiliary data 404 to be encoded in the example source data 402 in the example of FIG. 4 is an ASCII character encoding of the letter “N,” which is the hexadecimal number 0x4E, or the binary number 01001110. The example auxiliary data 404 may be completely represented by assigning the data units to respective ones of eight groups (e.g., G0, G1, G2, G3, G4, G5, G6, and G7). The example data unit group assignor 208 of FIG. 2 applies a hash algorithm to each of the data units in the source data 402 to assign the data units to ones of the groups G0-G7. In the example of FIG. 4, the data units are assigned to the groups G0-G7 by dropping the least significant bit of the data unit value and performing a modulo 8 operation on the resulting number. The resulting assignments of the source data to the groups G0-G7 are illustrated in the table as X's in the row of a data unit and the column of the group G0-G7 to which it is assigned.

In the example of FIG. 4, the symbol group assignor 204 of FIG. 2 arranges the groups G0-G7 order from G0 as the least significant bit to G7 as the most significant bit of the auxiliary data 404. Thus, the data unit encoder 210 of FIG. 2 encodes a symbol corresponding to a ‘0’ bit in the data units of the source data 402 assigned to groups G0, G4, G5, and G7. Similarly, the data unit encoder 210 of FIG. 2 encodes symbols corresponding to bit ‘1’ in the data units of the source data 402 assigned to groups G1, G2, G3, and G6.

To encode a ‘0’ bit into a data unit, the example data unit encoder 210 increments or decrements the value of the data unit by 1 if the value is an odd number (e.g., to make the data unit an even number), and does not modify the value of the data unit if the value of the data unit is even. To encode a ‘1’ bit into a data unit, the example data unit encoder 210 increments or decrements the value of the data unit by 1 if the value is an even number (e.g., to make the data unit an odd number), and does not modify the value of the data unit if the value of the data unit is odd. As a result, the data units of the encoded data 406 are odd to represent a ‘1’ bit and are even to represent a ‘0’ bit. In some other examples, the representation may be reversed such that an odd number represents a ‘0’ bit and an even number represents a ‘1’ bit.

To obtain the auxiliary data 404 from the encoded data 406, the example data unit group assignor 304 of FIG. 3 assigns the data units of the encoded data 406 to the groups G0-G7. The example data unit group assignor 304 uses the same hash algorithm as used by the data unit group assignor 208 to assign the data units of the source data 402 to the groups G0-G7. The example hash algorithm results in the same group assignments when applied to the encoded data 406 and to the source data 402, because the potentially-modified figure is not used in the algorithm. As a result, the data units of the encoded data 406 are assigned to the same groups G0-G7 as the corresponding data units of the source data 402. The example symbol extractor 306 extracts the symbols from the example data units in the encoded data 406. In the example of FIG. 4, the symbol extractor 306 determines whether the numeric value of the least significant figure is odd or even. For example, if the numeric value is odd, the symbol extractor 306 determines the encoded symbol to be a ‘1’ bit. Conversely, if the numeric value is even, the symbol extractor 306 determines the encoded symbol to be a ‘0’ bit.

The example auxiliary data assembler 308 assembles the auxiliary data 404 by placing the extracted symbol of a data unit (e.g., from the symbol extractor 306) into the positions corresponding to the group assigned to that data unit. For example, the auxiliary data assembler 308 places the symbol ‘1,’ extracted from an encoded data unit assigned to group G1, into the bit location designated for group G1. The example auxiliary data assembler 308 assembles the complete auxiliary data 404 by placing the symbols for the other groups G0, G2, G3, G4, G5, G6, and G7 into their respective bit locations. The example auxiliary data assembler 308 then outputs the resulting auxiliary data 404 for, for example, matching with auxiliary data previously encoded into source data.

In the example of FIG. 4, the auxiliary data 404 may be obtained from as few as 8 data units of the encoded data. In this manner, the example encoding/decoding method disclosed herein can be very robust in that the auxiliary data or watermark can be obtained from even relatively small subsets of the encoded data 406. In some examples the auxiliary data decoder 300 of FIG. 3 iterates the method for additional ones of the encoded data units to, for example, perform error checking, to reduce the likelihood that a false positive has occurred, and/or to determine an extent to which a data set includes the encoded data 406.

In some examples, the data unit encoder 210 is constrained in its possible methods of encoding to not substantially modify the data (e.g., to not change to the data such that the data exceeds an error margin of the source data). Additionally or alternatively, the data unit encoder 210 may be constrained in its possible methods of encoding to not modify figures of the data that have a likelihood of being dropped by a user of the data. For example, encoding data units at the level of ones, tens, or hundreds where the data units have numerical values on the scale of millions or billions may be lost if the user removes the encoded portion of the data (e.g., because the ones, tens, and/or hundreds places may be insignificant to the data).

FIG. 5 is a table 500 illustrating another example of source data 502, auxiliary data 504, and resulting encoded data 506. In the example of FIG. 5, each data unit of the source data 502 is encoded with a respective symbol representative of two bits rather than one bit. The auxiliary data 504 of FIG. 5 includes two characters ‘NA,’ having a hexadecimal representation 0x4E41, or a binary representation 0100111001000001.

In contrast to the example of FIG. 4, the example data unit encoder 210 of FIG. 2 encodes the symbols into the source data 502 of FIG. 5 by selectively modifying the two least significant figures of the numeric value of the data unit based on the value of the symbol to be encoded. The data unit encoder 210 selectively modifies the least significant figure of the data unit based on the value of the least significant bit of the symbol, and selectively modifies the second least significant figure of the data unit based on the value of the most significant bit of the symbol. For example, for data units of the source data 502 that are assigned to the group G0 (e.g., groups assigned the symbol ‘01’), the example data unit encoder 210 selectively modifies the least significant figure of the data unit to be odd and selectively modifies the second least significant figure of the data unit to be even. For the example value 17204 illustrated in FIG. 4, the data unit encoder 210 modifies the least significant figure ‘4’ to be odd (e.g., increments the figure to a ‘3’ to represent the ‘1’ bit of the symbol) and does not modify the second least significant figure ‘0’ because the figure is already even (e.g., already represents the ‘0’ bit of the symbol). The example data unit encoder 210 modifies both of the two least significant figures of the example value 8150, which belongs to group G7 and is to be encoded with a ‘01’ symbol in the example of FIG. 5. The resulting encoded data unit value is 8161.

To obtain the auxiliary data 504 from the example encoded data 506 of FIG. 5, the example symbol extractor 306 of FIG. 3 determines, for each of the two least significant figures of each data unit, whether the figure is odd or even. If the least significant figure is even, the example symbol extractor 306 determines that the least significant bit of the symbol is a ‘0.’ If the least significant figure is odd, the example symbol extractor 306 determines that the least significant bit of the symbol is a ‘1.’ The symbol extractor 306 performs the same evaluation for the second least significant figure of the data unit to determine the most significant bit of the symbol. The example auxiliary data assembler 308 assembles the auxiliary data 504 by placing the extracted symbols from the data units into locations based on the respective assigned groups G0-G7 for the data units. For example, the auxiliary data assembler 308 of FIG. 3 determines that the symbol extracted from the data unit(s) belonging to group G0 represent the least significant bits of the auxiliary data 504. Similarly, the auxiliary data assembler 308 determines that the symbol extracted from the data unit(s) belonging to group G1 represent the next least significant bits of the auxiliary data 504, and so on through the symbol extracted from the data unit(s) belonging to group G7.

The example encoding scheme illustrated in FIG. 5 encodes more data into the same source data 402 compared to the scheme of FIG. 4. However, the encoding scheme of FIG. 5 changes the data more significantly than the example scheme of FIG. 4. In the case that the changes to the values are not significant, the encoding of the example scheme of FIG. 5 may be more likely to be lost due to a user eliminating least significant figure(s) from the data units.

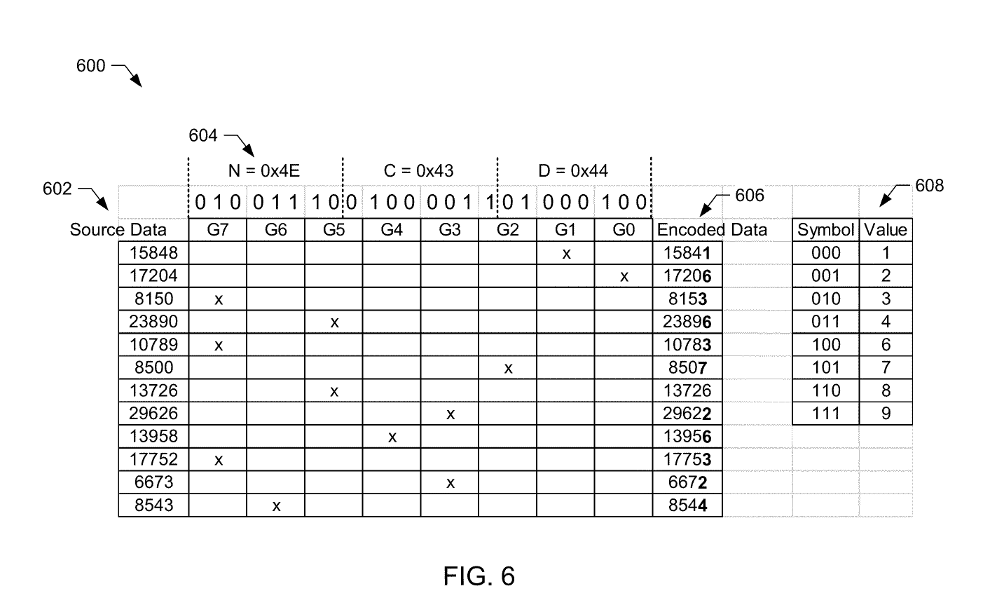

FIG. 6 is a table 600 illustrating another example of source data 602, auxiliary data 604, and resulting encoded data 606. In the example of FIG. 6, the data unit encoder 210 encodes symbols into the data units by selectively modifying the least significant figure of the data unit to be a number based on a mapping of numbers to symbols. A mapping table 608 illustrates the example mapping between symbols and numbers designated to represent the symbols (e.g., designated numbers). Using the example mapping table 608 of FIG. 6, the data unit encoder 210 encodes a ‘100’ binary symbol into data units assigned to groups G0, G4, and G5 by modifying the least significant figure of the data units to be a ‘6’ (e.g., if the least significant figures of the data units are not already a ‘6’). Similarly, the example data unit encoder 210 encodes a ‘000’ symbol into data units assigned to group G1 by selectively modifying the least significant figure of the data units to a ‘1.’

To obtain the auxiliary data 604 from the example encoded data 606 of FIG. 6, the example symbol extractor 306 of FIG. 3 determines the least significant figure of a data unit and determines the corresponding symbol based on the mapping table 608. If the least significant figure is even, the example symbol extractor 306 determines that the least significant bit of the symbol is a ‘0.’ If the least significant figure is odd, the example symbol extractor 306 determines that the least significant bit of the symbol is a ‘1.’ The symbol extractor 306 performs the same evaluation for the second least significant figure of the data unit to determine the most significant bit of the symbol. The example auxiliary data assembler 308 assembles the auxiliary data 504 by placing the extracted symbols from the data units into locations based on the respective assigned groups G0-G7 for the data units.

While the example of FIG. 6 uses 3-bit symbols and maps each symbol to one corresponding value, the number of bits per symbol may be greater or fewer and/or each symbol may be represented by more or fewer values. For example, additional figures of the data unit may be modified to reflect the values.

While example manners of implementing the system 100 of FIG. 1 has been illustrated in FIGS. 2 and/or 3, one or more of the elements, processes and/or devices illustrated in FIGS. 2 and/or 3 may be combined, divided, re-arranged, omitted, eliminated and/or implemented in any other way. Further, the example database 102, the example data request receiver 104, the example auxiliary data manager 110, the example auxiliary data encryptor 202, the example symbol group assignor 204, the example source data parser 206, the example data group assignor 208, the example data unit encoder 210, the example encoded data parser 302, the example data unit group assignor 304, the example symbol extractor 306, the example auxiliary data assembler 308, the example auxiliary data encryptor 310 and/or, more generally, the example auxiliary data encoder 106, 200 and/or the example auxiliary data decoder 108, 300 of FIGS. 1-3 may be implemented by hardware, software, firmware and/or any combination of hardware, software and/or firmware. Thus, for example, any of the example database 102, the example data request receiver 104, the example auxiliary data manager 110, the example auxiliary data encryptor 202, the example symbol group assignor 204, the example source data parser 206, the example data group assignor 208, the example data unit encoder 210, the example encoded data parser 302, the example data unit group assignor 304, the example symbol extractor 306, the example auxiliary data assembler 308, the example auxiliary data encryptor 310 and/or, more generally, the example auxiliary data encoder 106, 200 and/or the example auxiliary data decoder 108, 300 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example database 102, the example data request receiver 104, the example auxiliary data manager 110, the example auxiliary data encryptor 202, the example symbol group assignor 204, the example source data parser 206, the example data group assignor 208, the example data unit encoder 210, the example encoded data parser 302, the example data unit group assignor 304, the example symbol extractor 306, the example auxiliary data assembler 308, and/or the example auxiliary data encryptor 310 are hereby expressly defined to include a tangible computer readable storage medium such as a memory, DVD, CD, Blu-ray, etc. storing the software and/or firmware. Further still, the example the example auxiliary data encoder 106, 200 and/or the example auxiliary data decoder 108, 300 of FIGS. 1-3 may include one or more elements, processes and/or devices in addition to, or instead of, those illustrated in FIGS. 1-3, and/or may include more than one of any or all of the illustrated elements, processes and devices.

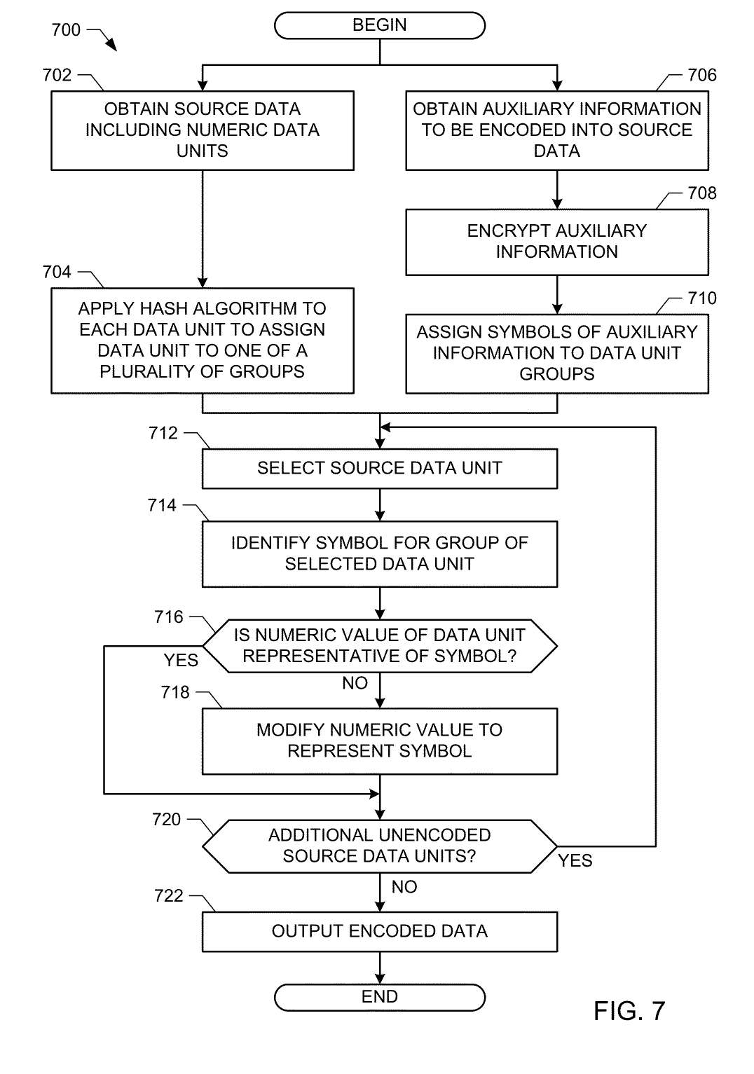

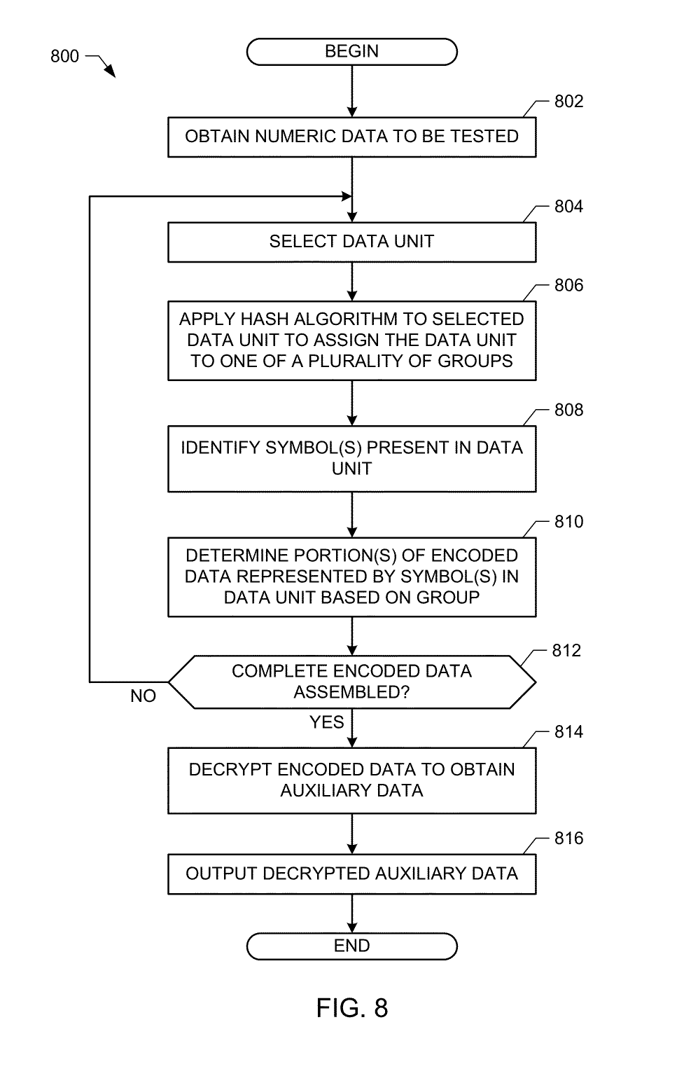

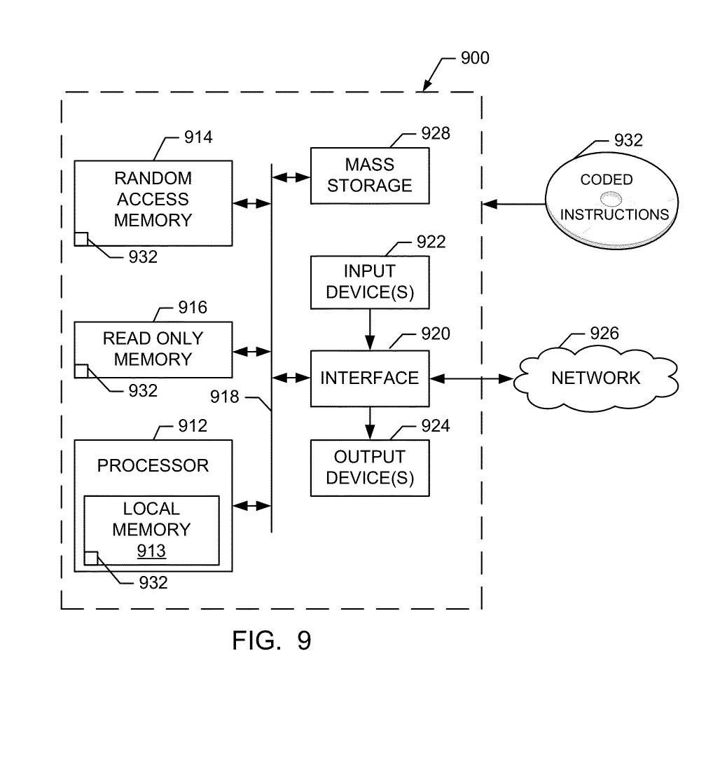

A flowchart representative of example machine readable instructions for implementing the example auxiliary data encoder 200 of FIG. 2 is shown in FIG. 7. A flowchart representative of example machine readable instructions for implementing the example auxiliary data decoder 300 of FIG. 3 is shown in FIG. 8. In this example, the machine readable instructions comprise programs for execution by a processor such as the processor 912 shown in the example computer 900 discussed below in connection with FIG. 9. The programs may be embodied in software stored on a tangible computer readable storage medium such as a CD-ROM, a floppy disk, a hard drive, a digital versatile disk (DVD), a Blu-ray disk, or a memory associated with the processor 912, but the entire programs and/or parts thereof could alternatively be executed by a device other than the processor 912 and/or embodied in firmware or dedicated hardware. Further, although the example programs are described with reference to the flowcharts illustrated in FIGS. 7 and 8, many other methods of implementing the example auxiliary data encoder 200 and/or the example auxiliary data decoder 300 may alternatively be used. For example, the order of execution of the blocks may be changed, and/or some of the blocks described may be changed, eliminated, or combined.

As mentioned above, the example processes of FIGS. 7-8 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage and to exclude propagating signals. Additionally or alternatively, the example processes of FIGS. 7-8 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable storage medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 7 is a flowchart representative of example machine readable instructions 700 which may be executed to implement the auxiliary data encoder 200 of FIG. 2 to encode auxiliary data into numeric data. The example instructions 700 may be performed, for example, to embed a watermark, such as an identifier or copyright information, into the numeric data prior to providing the numeric data to another party.

The example source data parser 206 of FIG. 2 obtains source data including numeric data units (block 702). In some examples, the source data parser 206 generates the data units from numeric data. The example data unit group assignor 208 of FIG. 2 applies a hash algorithm to each data unit (e.g., from the source data parser 206) to assign the data unit to one of a plurality of groups (block 704). An example hash algorithm is described above, but any hash algorithm may be used to assign the data units to respective ones of the groups.

The example auxiliary data encryptor 202 obtains auxiliary information to be encoded into the source data (block 706). The auxiliary data encryptor 202 encrypts the auxiliary information (block 708). The example data unit group assignor 208 assigns symbols of the encrypted auxiliary information to respective data unit groups (e.g., the data unit groups to which the data units are assigned). In some examples, blocks 702-704 are performed in parallel with blocks 706-710.

The example data unit encoder 210 of FIG. 2 selects a source data unit (block 712). The example data unit encoder 210 identifies a symbol for the group of the selected data unit (block 714). To encode the symbol in the data unit, the example data unit encoder 210 determines whether the numeric value of the data unit is representative of the symbol to be encoded (block 716). For example, in cases in which the symbol is encoded by selectively modifying the least significant figure to be odd or even, an odd (or even) value may already represent a ‘1’ symbol (or a ‘0’ symbol), or vice versa.

If the numeric value is not representative of the symbol (block 716), the example data unit encoder 210 modifies the numeric value to represent the symbol (block 718). For example, the data unit encoder may modify one or more figures of the numeric value to be odd and/or even and/or modify one or more figures of the numeric value to have a designated value mapped to the symbol.

After modifying the numeric value (block 718) or if the numeric value is already representative of the symbol (block 716), the example data unit encoder 210 determines whether there are additional unencoded source data units (block 720). If there are additional unencoded source data units (block 720), control returns to block 712 to select another source data unit to be encoded. When there are no additional data units (block 720), the example data unit encoder 210 outputs the encoded data (block 722). The encoded data may, for example, be transmitted or stored for future transmission. The example instructions 700 may then end and/or iterate to encode another symbol into numeric data.

FIG. 8 is a flowchart representative of example machine readable instructions 800 which may be executed to implement the auxiliary data decoder 300 of FIG. 3 to obtain auxiliary data encoded into numeric data. The example instructions 800 of FIG. 8 may be performed to, for example, identify copyrighted data and/or to extract information such as a watermark that is encoded into numeric data.

The example encoded data parser 302 of FIG. 3 obtains numeric data to be tested (block 802). In some examples, the encoded data parser 302 generates data units from the obtained data. The example data unit group assignor 304 of FIG. 3 selects a data unit (block 804). The data unit group assignor 304 applies a hash algorithm to the selected data unit to assign the selected data unit to one of a plurality of groups (block 806).

The example symbol extractor 306 identifies symbol(s) present in the selected data unit (block 808). For example, the symbol extractor 306 may determine whether one or more figure(s) of the numeric value of the data unit are odd and/or even, and/or determine a mapping of a value of one or more figures of the numeric value to a symbol. Based on the group corresponding to the symbol(s), the example auxiliary data assembler 308 determines a portion of the encoded data represented by the symbol(s) in the data unit (block 810). For example, the auxiliary data assembler 308 may determine a placement of the symbol(s) within the encoded information based on a portion of the encoded information assigned to the symbol (e.g., an ordering of the groups).

The example auxiliary data assembler 308 determines whether the complete encoded data has been assembled (block 812). For example, the auxiliary information assembler 308 may determine whether a symbol has been extracted and placed for each group. If the complete encoded data has not been assembled (block 812), control returns to block 804 to select another data unit. If the complete encoded data has been assembled (block 812), the example auxiliary data decryptor decrypts the encoded data to obtain auxiliary data (block 814). The example auxiliary data decryptor 310 outputs the decrypted auxiliary data (block 816). For example, the decrypted auxiliary data may be used for comparison to auxiliary data encoded into source data to determine a match and/or to obtain information encoded into the data.

FIG. 9 is a block diagram of an example computer 900 capable of executing the instructions of FIGS. 7 and/or 8 to implement the auxiliary data encoder 200 and/or the auxiliary data decoder 300 of FIGS. 1-3. The computer 900 can be, for example, a server, a personal computer, an Internet appliance, or any other type of computing device.

The system 900 of the instant example includes a processor 912. For example, the processor 912 can be implemented by one or more microprocessors or controllers from any desired family or manufacturer.

The processor 912 includes a local memory 913 (e.g., a cache) and is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The computer 900 also includes an interface circuit 920. The interface circuit 920 may be implemented by any type of interface standard, such as an Ethernet interface, a universal serial bus (USB), and/or a PCI express interface.

One or more input devices 922 are connected to the interface circuit 920. The input device(s) 922 permit a user to enter data and commands into the processor 912. The input device(s) can be implemented by, for example, a keyboard, a mouse, a touchscreen, a voice recognition system, and/or any other method of input or input device.

One or more output devices 924 are also connected to the interface circuit 920. The output devices 924 can be implemented, for example, by display devices (e.g., a liquid crystal display, a cathode ray tube display (CRT), a printer and/or speakers). The interface circuit 920, thus, typically includes a graphics driver card.

The interface circuit 920 also includes a communication device such as a modem or network interface card to facilitate exchange of data with external computers via a network 926 (e.g., an Ethernet connection, a digital subscriber line (DSL), a telephone line, coaxial cable, a cellular telephone system, etc.).

The computer 900 also includes one or more mass storage devices 928 for storing software and data. Examples of such mass storage devices 928 include floppy disk drives, hard drive disks, compact disk drives and digital versatile disk (DVD) drives. The mass storage device 928 may implement the database 102 of FIG. 1.

The coded instructions 932 of FIGS. 7 and/or 8 may be stored in the mass storage device 928, in the volatile memory 914, in the non-volatile memory 916, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. A method to encode auxiliary information into numeric data, comprising:
assigning source data to one of a plurality of groups, the source data comprising a numeric value;
identifying a symbol to be added to the source data based on an assigned group of the source data; and
generating encoded data by selectively modifying the numeric value of the source data to be representative of the symbol.

2. A method as defined in claim 1, wherein modifying the numeric value comprises modifying the least significant figure of the numeric value.

3. A method as defined in claim 2, wherein selectively modifying the numeric value comprises increasing or decreasing the least significant figure by one to be representative of the symbol.

4. A method as defined in claim 2, wherein selectively modifying the numeric value comprises causing the least significant figure to be odd or even to be representative of the symbol.

5. A method as defined in claim 1, wherein selectively modifying the numeric value comprises not modifying the numeric value when the numeric value is representative of the symbol.

6. A method as defined in claim 1, wherein the source data comprises a unit of numeric data and a plurality of units are to be assigned to corresponding ones of the plurality of groups based on a hash function.

7. A method as defined in claim 6, further comprising dividing auxiliary data by the plurality of groups, wherein the symbol is representative of a portion of the auxiliary data.

8. A method as defined in claim 1, wherein selectively modifying the numeric value comprises modifying the numeric value to be a designated number based on a mapping of the symbol to the designated number.

9-14. (canceled)

15. An apparatus to encode auxiliary information into numeric data, comprising:
a data unit group assignor to assign source data to one of a plurality of groups, the source data comprising a numeric value;
a symbol group assignor to assign a symbol to be added to the source data to the one of the plurality of groups; and
a data unit encoder to generate encoded data by selectively modifying the numeric value of the source data to be representative of the symbol.

16. An apparatus as defined in claim 15, wherein the data unit encoder is to modify the numeric value by modifying the least significant figure of the numeric value.

17. An apparatus as defined in claim 16, wherein the data unit encoder is to selectively modify the numeric value by increasing or decreasing the least significant figure by one to be representative of the symbol.

18. An apparatus as defined in claim 16, wherein the data unit encoder is to selectively modify the numeric value by modifying the least significant figure to be odd or even to be representative of the symbol.

19. An apparatus as defined in claim 15, wherein the data unit encoder is to selectively modify the numeric value by not modifying the numeric value when the numeric value is representative of the symbol.

20. An apparatus as defined in claim 15, wherein the source data comprises a unit of numeric data, the data unit group assignor to assign a plurality of units to corresponding ones of the plurality of groups based on a hash function.

21. An apparatus as defined in claim 20, wherein the symbol group assignor is to divide the auxiliary information by the plurality of groups, wherein the symbol is representative of a portion of the auxiliary information.

22. An apparatus as defined in claim 15, wherein the data unit encoder is to selectively modify the numeric value by modifying the numeric value to be a designated number based on a mapping of the symbol to the designated number.

23-28. (canceled)

29. A computer readable storage medium comprising computer readable instructions which, when executed, cause a processor to at least:
assign source data to one of a plurality of groups, the source data comprising a numeric value;
identify a symbol to be added to the source data based on an assigned group of the source data; and
generate encoded data by selectively modifying the numeric value of the source data to be representative of the symbol.

30. A computer readable storage medium as defined in claim 29, wherein the instructions are to cause the processor to modify the numeric value by modifying the least significant figure of the numeric value.

31. A computer readable storage medium as defined in claim 30, wherein the instructions are to cause the processor to selectively modify the numeric value by increasing or decreasing the least significant figure by one to be representative of the symbol.

32. A computer readable storage medium as defined in claim 30, wherein the instructions are to cause the processor to selectively modify the numeric value by causing the least significant figure to be odd or even to be representative of the symbol.

33. A computer readable storage medium as defined in claim 29, wherein the instructions are to cause the processor to selectively modify the numeric value by not modifying the numeric value when the numeric value is representative of the symbol.

34. A computer readable storage medium as defined in claim 29, wherein the source data comprises a unit of numeric data and a plurality of units are to be assigned to corresponding ones of the plurality of groups based on a hash function.

35. A computer readable storage medium as defined in claim 34, wherein the instructions further cause the processor to divide auxiliary data by the plurality of groups, wherein the symbol is representative of a portion of the auxiliary data.

36. A computer readable storage medium as defined in claim 29, wherein the instructions are to cause the processor to selectively modify the numeric value by modifying the numeric value to be a designated number based on a mapping of the symbol to the designated number.

37-42. (canceled)
